(19) United States
(12) Patent Application Publication
(10) Pub. No.: US 2007/0221259 A1
(43) Pub. Date: Sep. 27, 2007

(54) Multi-use kitchen appliance

(76) Inventors: Joann K. Drago, Jacksonville, OR (US); James M. Drago, Prospect, OR (US)

Correspondence Address: Robert E. Howard, P.O. Box 10345, Eugene, OR, 97440-2345, US

(21) Appl. No.: 11/804,394

(22) Filed: May 17, 2007

Related U.S. Application Data
(63) Continuation-in-part of application No. 10/657,113, filed on Sep. 9, 2003.

(51) Int. Cl. B08B 3/04

(52) U.S. Cl. 134/57 D; 134/56 D

(57) ABSTRACT

A multi-use kitchen appliance which can be used for dishwashing, washing produce, and dehydrating food. The appliance includes an article holding unit having article retaining means located in the interior thereof, water introduction means, air heating and air introduction means, and means for introducing a cleaning agent and/or disinfectant. Controller means can be set to cause the water to be introduced into the interior of the article holding unit at selected temperatures, pressures, and period or periods of time for dishwashing and washing produce. The controller means can also be set to introduce heated air into the interior at selected temperatures and for a selected period or periods of time to dehydrate food. The controller means can be set to introduce a cleaning agent and/or disinfectant into the interior in selected amounts and for a selected period or periods of time.

### CROSS-REFERENCE TO RELATED APPLICATIONS

This application is a continuation-in-part of U.S. patent application Ser. No. 10/657,113 filed Sep. 9, 2003, the entire contents of which application is hereby incorporated by reference.

### BACKGROUND OF THE INVENTION

This invention relates to a multi-use kitchen appliance. More particularly, this invention relates to a kitchen appliance designed to automatically wash dishes, wash produce, and dehydrate food.

In the past typical dishwashers have used only hot water supplied from a domestic source such as a hot water heater. Such dishwashers are single application appliances designed to wash dishes and other kitchen utensils in hot water, and then to dry the contents automatically if desired.

In the past few real improvements have been made to the dishwasher appliance. The most notable improvement has been the addition of varying cycles. Another improvement was the designing of different ways to configure the interior shelving which gave more room for the contents that were being washed. Yet another improvement was providing for the interior shelving of the dishwasher to be pulled out like a drawer to make it easier to load.

### SUMMARY OF THE INVENTION

It is an object of this invention to provide a single appliance that can be used to wash dishes, wash produce, and dehydrate food.

The appliance includes an article holding unit having article retaining means located in the interior thereof, water heating and introduction means, air heating and introduction means, and means for introducing a cleaning agent and/or disinfectant.

Controller means can be set to cause the water to be introduced into the interior of the article holding unit at selected temperatures, pressures, and period. or periods of times for dishwashing and washing produce.

The controller means can also be set to heat ambient air to a selected temperature in an air heating means, and to introduce the heated air into the interior of the appliance for a selected period or periods of time to dehydrate food.

The controller means can be set to introduce a cleaning agent and/or disinfectant into the interior in selected amounts and for a selected period or periods of time.

### BRIEF DESCRIPTION OF THE DRAWINGS

FIG. 1 is a schematic diagram of the multi-use kitchen appliance of the present invention; and

FIG. 2 is a schematic diagram of an alternative embodiment of the multi-use kitchen appliance of the present invention.

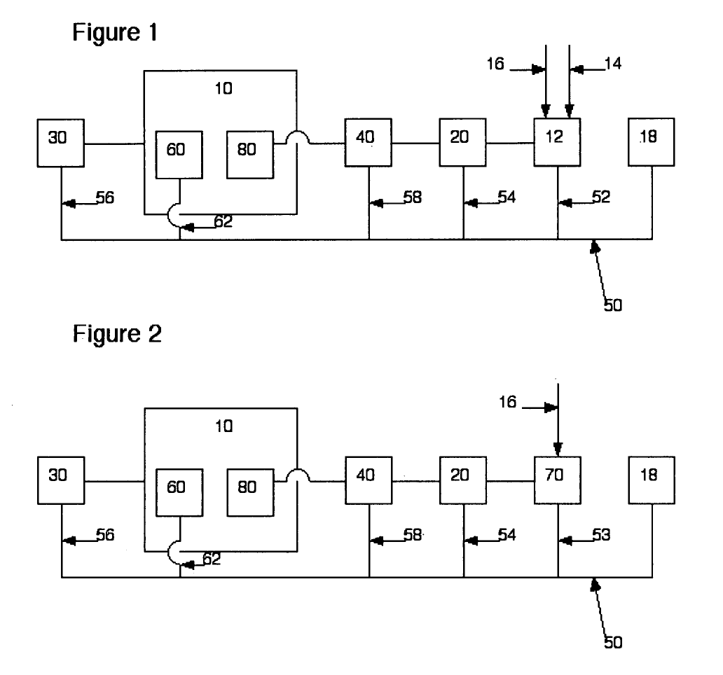

### DESCRIPTION OF PREFERRED EMBODIMENTS

In the drawings the reference numbers refer to the following elements of the invention:

10: Article holding unit

12: Dual input water proportioning and mixing valve

14: Hot water line

16: Cold water line

18: Controller—either a CPU or an electro mechanical controller

20: Variable pressure water pump

30: Air heating source and fan unit

40: Ozone generator

50: Electric line from CPU or controller

52: Electric line from line 50 to dual input mixing valve 12

53: Electric line from line 50 to water heater unit 70 (FIG. 2)

54: Electric line from line 50 to variable pressure pump 20

56: Electric line from line 50 to air heating source 30

58: Electric line from line 50 to ozone generator 40

60: Disinfectant injector unit

62: Electric line from line 50 to disinfectant injector 60

70: A water heater unit (FIG. 2)

80: Water distribution unit

Article holding unit 10 has a top, bottom, rear wall, side walls and a front wall that has an access door adapted to provide access to the interior of the article holding unit, and is similar in construction to a conventional residential kitchen dishwasher unit. The interior of article holding unit 10 has shelves, baskets, trays, racks, bags, and/or other article retaining means that are adapted to be configured in a number of ways to meet the requirements of the chosen cycle, i.e., dishwashing, produce washing, or food dehydration.

The article holding unit 10 is supplied with both hot and cold water via hot and cold water lines 14 and 16, respectively, which passes through a dual input water proportioning and mixing valve 12 controlled by controller 18 in a manner similar to that used on typical clothes washers. Alternatively, as shown in FIG. 2, cold water from cold water line 16 is fed into a water heater unit 70 where it is heated to a temperature selected by controller 18. The water is introduced into the interior of the article holding unit 10 and distributed over articles held by the article retaining means located within the interior of article holding unit 10 in a manner well known in the conventional dishwasher art.

A variable pressure water pump 20 controlled by controller 18 allows the pressure of water being fed into article holding unit 10 to be adjusted to provide, for example, a cold gentle wash for washing produce or a strong hot wash for dishes. The addition of adjustable or interchangeable jets would also allow the appliance to offer a gentle wash or a strong jet of water to be used.

To wash dishes, controller 18 is set to the dishwashing cycle. The article holding unit 10 is loaded with dishes placed upon its shelves and racks, similar to a conventional dishwasher. Controller 18 can be set to inject ozone from ozone generator 40 into the heated water stream prior to its introduction into the interior of article holding unit 10, and/or inject a disinfectant from disinfectant injector unit 60 into the interior of article holding unit 10. Controller 18 can also be set to a cycle compatible with the objects being washed, such as regular china, crystal, pots and pans, etc. Depending on the cycle chosen, controller 18 would control the water temperature by adjusting the amount of hot or cold water coming from hot water line 14 and cold water line 16 via dual input water proportioning and mixing valve 12. The hot water in hot water line 14 can be provided by a domestic hot water heater. Alternatively hot water at a temperature set by controller 18 can be generated by a water heater unit 70 (FIG. 2) which heats cold water introduced from cold water line 16. A heated air drying cycle can be selected with controller 18 to provide heated air from air heating source and fan unit 30. Controller 18 would also control the temperature to which the air is heated in unit 30 and the time period or periods for introduction of heated air into article holding unit 10. Article holding unit 10 is preferably vented to allow heated air to be exhausted, in the same manner as a typical clothes dryer.

To wash produce, the shelves, baskets, trays, racks, and bags within article holding unit 10 are appropriately configured to receive the produce being washed. The article holding unit 10 is then loaded with the produce to be washed and controller 18 set to the produce washing cycle. A cleaning agent (ozone injected from ozone generator 40) and/or a disinfectant (injected from disinfectant injector unit 60) can be selected with controller 18, as desired. Controller 18 can also be used to set produce washing cycle parameters. Depending on the cycle chosen, controller 18 would adjust the time and amount of hot or cold water coming from hot water line 14 and cold water line 16 via adjustment of dual input water proportioning and mixing valve 12. The hot water in hot water line 14 can be provided by a domestic hot water heater. Alternatively hot water at a temperature set by controller 18 can be generated by a water heater unit 70 (FIG. 2) which heats cold water introduced from cold water line 16. An air drying time cycle and air temperature can, optionally, be chosen by use of controller 18 to activate air heating source and fan unit 30. Controller 18 would also control the temperature to which the air is heated in unit 30 and the time period or periods for introduction of heated air into article holding unit 10. Article holding unit 10 is preferably vented to allow heated air to be exhausted, in the same manner as a typical clothes dryer.

To use article holding unit 10 to dehydrate food, the shelves, baskets, trays, racks, and bags within article holding unit 10 are appropriately configured to receive the food to be dehydrated. Controller 18 is set to cause air heating source and fan unit 30 to heat ambient air to a selected temperature and to provide dehydrating heated air to article holding unit 10 for a selected period or periods of time. Time of exposure and air temperature for a particular article and quantity of food to be dehydrated are well known in the food dehydration art. Again, article holding unit 10 is preferably vented.

It will be obvious to those having skill in the art that many changes may be made to the details of the above-described embodiments of this invention without departing from the underlying principles thereof The scope of the present invention should, therefore, be determined only by the following claims.

The invention claimed is:

1. A multi-use kitchen appliance that can be used for dishwashing, washing produce, and dehydrating food comprising:
an article holding unit having a top, bottom, rear wall, side walls, and a front wall having an access door adapted to provide access to the interior of said article holding unit;
said interior of said article holding unit having article retaining means located therein;
water heater means for heating water and means for introducing the heated water into said interior of said article holding unit;
air heating means for heating ambient air and means for introducing the heated air into said interior of said article holding unit;
means for introducing a cleaning agent and/or disinfectant into said interior of said article holding unit; and
a controller means adapted to cause introduction of said heated water, said heated air, said cleaning agent and/or disinfectant, or any combination thereof, into said interior of said article holding unit for a selected time period or periods, and for selecting the temperature to which said water and said air are to be heated.

2. The multi-use kitchen appliance of claim 1 wherein means for selecting the temperature of said water is a dual input water proportioning and mixing valve adapted to receive and mix hot and cold water in amounts determined by said controller.

3. The multi-use kitchen appliance of claim 1 wherein said controller is a CPU.

4. The multi-use kitchen appliance of claim 1 wherein said controller is an electro mechanical controller.

5. The multi-use kitchen appliance of claim 1 wherein means for selecting the temperature of said water is a water heater controlled by said controller.

6. The multi-use kitchen appliance of claim 1 including a variable pressure water pump adapted to pressurize said heated water prior to its introduction into said interior of said article holding unit.

7. The multi-use kitchen appliance of claim 6 wherein said heated water is pressurized to a pressure set by said controller.

8. The multi-use kitchen appliance of claim 1 wherein said means for introducing a cleaning agent and/or disinfectant includes an ozone generator and means for introducing ozone into the heated water prior to its introduction into said interior of said article holding unit.

9. The multi-use kitchen appliance of claim 8 including a disinfectant injector unit adapted to introduce a disinfectant into the interior of said article holding unit

10. A multi-use kitchen appliance that can be used for dishwashing, washing produce, and dehydrating food comprising:
an article holding unit having a top, bottom, rear wall, side walls, and a front wall having an access door adapted to provide access to the interior of said article holding unit;
said interior of said article holding unit having article retaining means located therein;
water heater means for heating water, said water heater means including a dual input water proportioning and mixing valve adapted to receive hot water from a hot water line and cold water from a cold water line, and to mix said hot and cold water in amounts adapted to achieve a selected water temperature;
means for introducing the heated water at said selected water temperature into said interior of said article holding unit and distributing said heated water over articles held by said article retaining means located within the interior of said article holding unit;
air heating means for heating ambient air to a selected air temperature;
means for introducing the heated air at said selected air temperature into said interior of said article holding unit and circulating it about articles held by said article retaining means located within the interior of said article holding unit;
vent means for exhausting said heated air from the interior of said article holding unit;
an ozone generator and means for introducing ozone into the heated water prior to its introduction into said interior of said article holding unit;
a disinfectant injector unit adapted to introduce a disinfectant into the interior of said article holding unit; and
a controller means adapted to cause introduction of said heated water, said heated air, said ozone, said disinfectant, or any combination thereof, into said interior of said article holding unit for a selected time period or periods, and for selecting the temperature to which said water in said water heating means and the temperature to which said air is to be heated in said air heating means.
